(19) United States
(12) Patent Application Publication
(10) Pub. No.: US 2026/0124910 A1
(43) Pub. Date: May 7, 2026

(54) VEHICLE CONTROL APPARATUS

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/372,876

(22) Filed: Oct. 29, 2025

(30) Foreign Application Priority Data
Nov. 5, 2024 (JP) 2024-193977

(51) Int. Cl. B60K 28/02; G06V 20/59; G06V 40/10; G06V 40/20

(52) U.S. Cl. CPC B60K 28/02; G06V 20/59; G06V 40/10; G06V 40/20

(57) ABSTRACT

A vehicle control apparatus includes a controller and an imager that captures an image of an interior of a vehicle. The controller detects an object from the image captured by the imager using an object detection technique, calculates seating likelihood indicating likelihood that a posture of the object is a seating posture from the image, and determines whether to perform a determination of a safe posture based on a movement amount of the object based on whether the seating likelihood is equal to or greater than a likelihood threshold, and performing of the determination based on the movement amount includes calculating the movement amount, and turning on a flag indicating that the posture of the object is a safe posture when the movement amount is equal to or less than a movement amount threshold, and turning off the flag when the movement amount exceeds the movement amount threshold.

### CROSS-REFERENCE TO RELATED APPLICATION

This application claims priority to Japanese Patent Application No. 2024-193977 filed on November 5, 2024, the entire contents of which are incorporated herein by reference.

### TECHNICAL FIELD

The present disclosure relates to a vehicle control apparatus.

### BACKGROUND

Technology for determining the posture of a person is known. For example, Patent Literature (PTL) 1 discloses technology for calculating the likelihood that the posture of a person is a particular posture (e.g., lying posture) and determining that the posture of the person is the particular posture if the likelihood is equal to or greater than a threshold.

### CITATION LIST

### Patent Literature

PTL 1: JP 2024-046924 A

### SUMMARY

When posture judgment is used to determine permission to start a vehicle, it is desirable to determine that the posture of an occupant in the vehicle is a safe posture, e.g., a seating posture. Seating determination made by image recognition is mainly performed using machine learning. However, if the visibility of the occupant in the image or the installation angle of the camera is inappropriate, the accuracy of seating determination may decrease, and thus the accuracy of safe posture determination may also decrease.

It would be helpful to improve technology for determining the posture of a person.

A vehicle control apparatus according to an embodiment of the present disclosure includes: a controller; and an imager configured to capture an image of an interior of a vehicle, the controller is configured to: detect an object from the image captured by the imager using an object detection technique; calculate seating likelihood indicating likelihood that a posture of the object is a seating posture from the image; and determine whether to perform a determination of a safe posture based on a movement amount of the object based on whether the seating likelihood is equal to or greater than a likelihood threshold, and performing of the determination based on the movement amount of the object includes: calculating the movement amount of the object; and turning on a flag indicating that the posture of the object is a safe posture in a case in which the movement amount is equal to or less than a movement amount threshold, and turning off the flag in a case in which the movement amount exceeds the movement amount threshold.

According to an embodiment of the present disclosure, technology for determining the posture of a person is improved.

### BRIEF DESCRIPTION OF THE DRAWINGS

In the accompanying drawings:

FIG. 1 is a block diagram illustrating a schematic configuration of a vehicle control apparatus according to an embodiment of the present disclosure;

FIG. 2 is a flowchart illustrating operations of the vehicle control apparatus according to the present embodiment; and

FIG. 3 is a flowchart illustrating operations of a vehicle control apparatus according to another embodiment.

### DETAILED DESCRIPTION

Embodiments of the present disclosure will be described below, with reference to the drawings.

### Outline of Present Embodiment

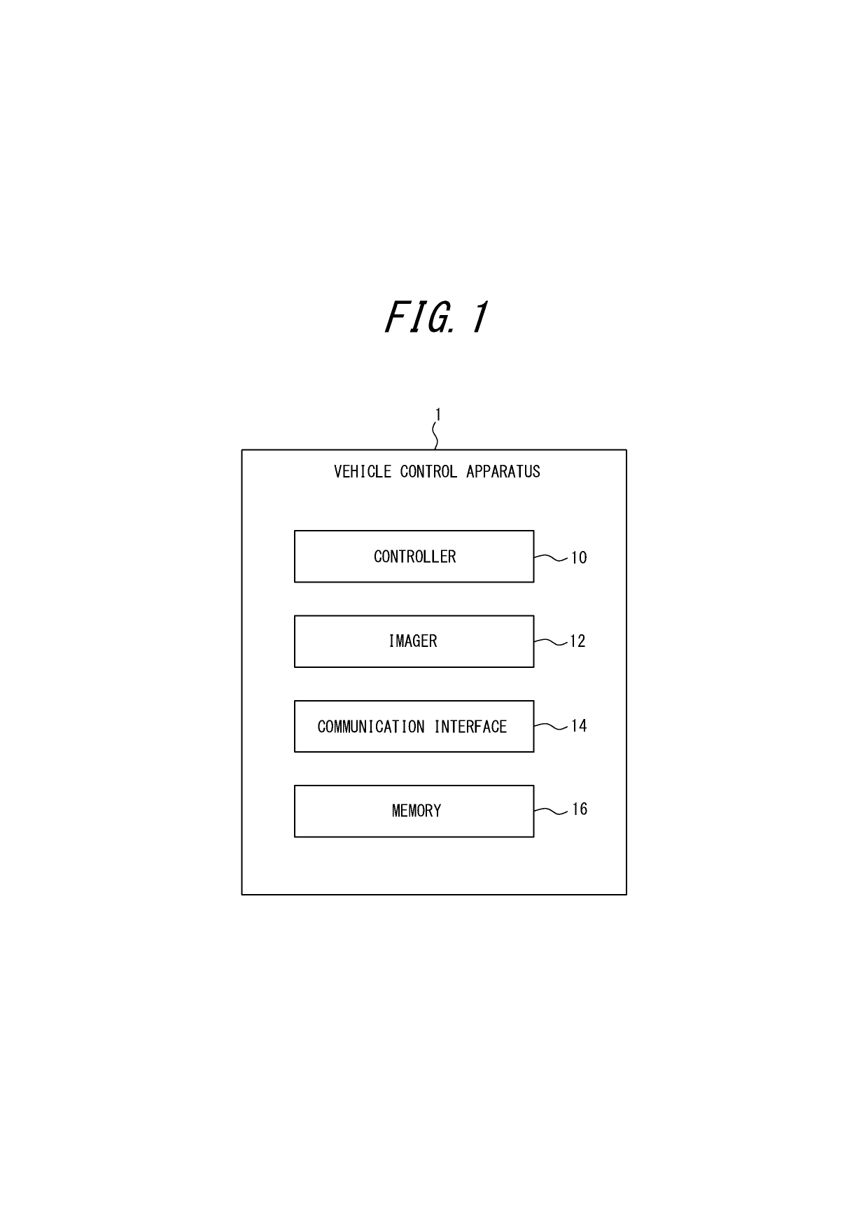

With reference to FIG. 1, an overview of the vehicle control apparatus 1 according to the embodiment of the present disclosure will be described. The vehicle control apparatus 1 is an electronic device mounted on the vehicle, for example, a computer. The vehicle control apparatus 1 detects an object from an image inside the vehicle using any object detection technique. The image may be a still image or a moving image. The object is an occupant inside the vehicle.

The vehicle is any vehicle capable of carrying one or more occupants, such as an automobile, bus, or shuttle bus. The vehicle may be an automated driving vehicle capable of automated driving at levels 1 to 5 as defined by the Society of Automotive Engineers (SAE). The vehicle may be a manually operated vehicle at level 0. The vehicle may be monitored remotely by an observer outside the vehicle. The vehicle may be a Mobility as a Service (MaaS) dedicated vehicle.

First, an overview of the present embodiment will be described. The vehicle control apparatus 1 according to the present embodiment includes a controller 10 and an imager 12 that captures an image of the interior of the vehicle. The controller 10 detects the object from the image captured by the imager 12 using an object detection technique. The controller 10 calculates a seating likelihood indicating the likelihood that the posture of the object is a seating posture from the image. The controller 10 determines whether to perform a determination of a safe posture based on a movement amount of the object based on whether the seating likelihood is equal to or greater than a likelihood threshold. Performing a determination of a safe posture based on a movement amount of the object includes calculating the movement amount of the object, and if the movement amount is equal to or less than a movement amount threshold, turning ON a flag indicating that the posture of the object is a safe posture, and if the movement amount exceeds the movement amount threshold, turning OFF the flag.

According to the present embodiment, not only a seating determination based on the seating likelihood but also a determination of a safe posture based on the movement amount of the object is performed to determine a safe posture. If the movement amount of the object is small, the likelihood of affecting the safe operation of the vehicle is low. Therefore, even if the accuracy of the seating determination decreases, it becomes possible to improve the accuracy of the determination of a safe posture by using the determination of a safe posture based on the movement amount of the object in conjunction.

### Configuration of Vehicle Control Apparatus 1

The vehicle control apparatus 1 includes a controller 10, an imager 12, a communication interface 14, and a memory 16. These parts are communicably connected to each other via an in-vehicle network, such as a Controller Area Network (CAN), or a dedicated line.

The controller 10 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing. The controller 10 executes processes related to operations of the vehicle control apparatus 1 while controlling components of the vehicle control apparatus 1.

The imager 12 is any imaging module that is installed in the vehicle and can image part or all of the seats and objects inside the vehicle. The imaging module includes one or more cameras. In the present embodiment, the imager 12 is a single camera installed on the ceiling of the vehicle. In the present embodiment, the imager 12 captures RGB images. The imager 12 may include a depth sensor that acquires depth images or a ranging device such as a stereo camera.

The communication interface 14 includes at least one interface for communication for connecting to an in-vehicle network. The interface for communication is compatible with, for example, a mobile communication standard such as the 4th generation (4G) or 5th generation (5G), a vehicle-to-everything (V2X) communication standard such as dedicated short range communications (DSRC) or cellular V2X, or a wireless local area network (LAN) communication standard such as Institute of Electrical and Electronics Engineers 802.11 (IEEE 802.11).

The memory 16 includes one or more memories. Various memories included in the memory 16 may function as, for example, a main memory, an auxiliary memory, or a cache memory. The memory 16 stores any information used for operations of the vehicle control apparatus 1. For example, the memory 16 stores system programs, application programs, embedded software, and any data used for object detection and posture estimation. The memory 16 may store information about the position and shape of each seat in advance. The information stored in the memory 16 may be updated with information acquired from the in-vehicle network or an external network via the communication interface 14. In the present embodiment, the state of a flag indicating that the posture of the object is a safe posture (ON or OFF) is updated by the controller 10 and also stored in the memory 16. The safe posture includes a seating posture when the object is seated in the seat and a stationary posture when the object is at rest or when the movement amount of the object is small.

In the present embodiment, the memory 16 stores an object detection AI that detects the object and its skeleton included in the captured image, and a posture estimation AI that estimates the posture of the object. The skeleton can be detected from the RGB image. To improve accuracy, depth images may also be used for skeleton detection. The object detection AI may include any object detection model such as You Only Look Once (YOLO) or Convolutional Neural Network (CNN). The posture estimation AI may include any posture estimation model that estimates the posture of the object from the object's skeleton.

### Operation Flow of Vehicle Control Apparatus 1 According to Present Embodiment

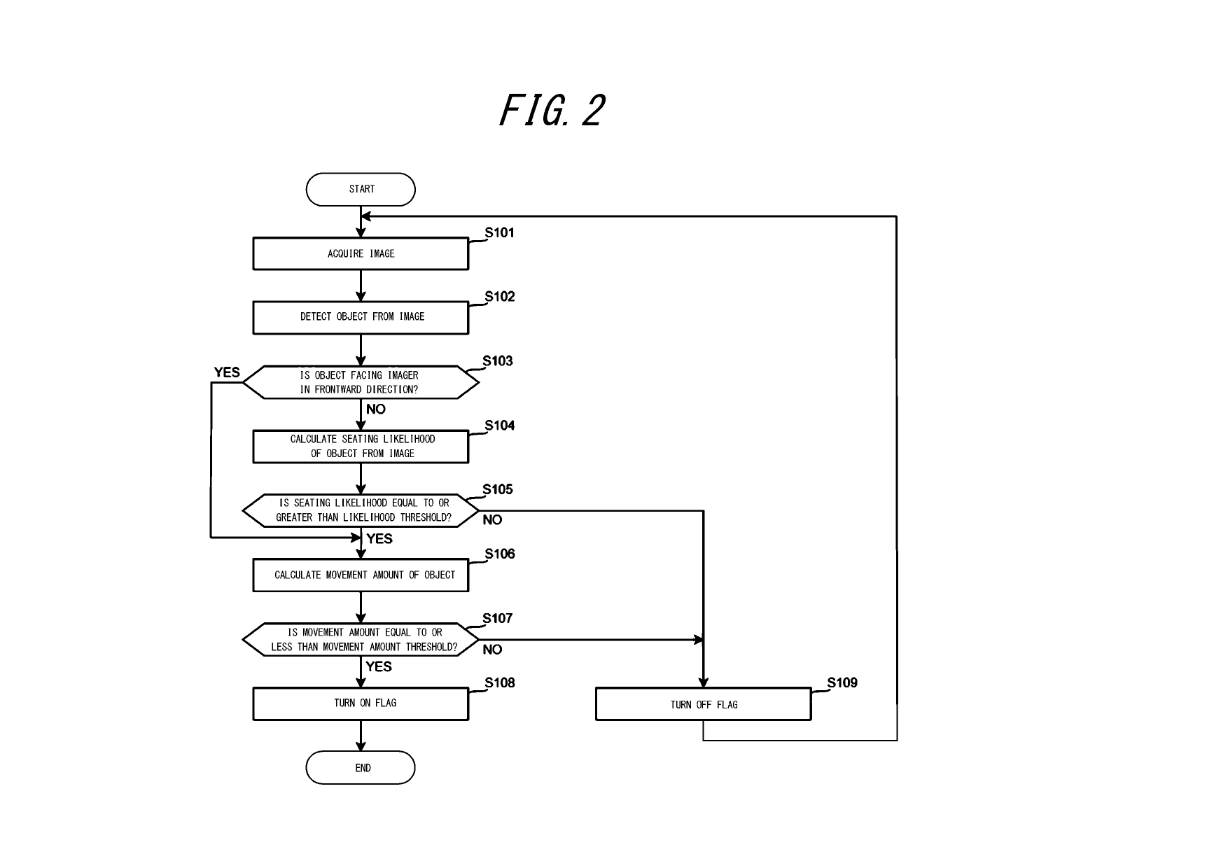

Operations of the vehicle control apparatus 1 according to the present embodiment will be described with reference to FIG. 2. The controller 10 determines whether the posture of each object in the vehicle is a safe posture by executing the following S101 to S109 while the vehicle is temporarily stopped at a stop. In the following, communication between the various parts of the vehicle control apparatus 1 is performed via the communication interface 14 and the in-vehicle network.

S101: The controller 10 of the vehicle control apparatus 1 acquires an image captured by the imager 12.

S102: The controller 10 detects the object from the image using object detection technology.

The controller 10 inputs the image captured by the imager 12 to the object detection AI stored in the memory 16 in advance. The object detection AI detects the presence of the object in the image based on the input image. The object detection AI may further detect the skeleton of the object based on the input image.

S103: The controller 10 determines whether the object is facing the frontward direction relative to the imager 12 from the image. If the object is facing the frontward direction, the process proceeds to S106. If the object is not facing the frontward direction, the process proceeds to S104.

The "frontward direction" is a direction that tilts within a range of, for example, 0 degrees to less than 45 degrees towards the direction from the object to the camera. If the object is not facing the frontward direction, it includes the case where the object is facing sideways. The "sideways direction" is a direction that tilts within a range of, for example, 45 degrees to less than 135 degrees towards the direction from the object to the camera.

Due to the camera's field of view or constraints of image processing, capturing the feature points of a person's posture from the front may make it difficult to detect the feature points compared to capturing them from another direction, such as sideways. Therefore, if the object is facing the frontward direction relative to the imager 12, the accuracy of the calculated seating likelihood may be low. In this embodiment, when the object is facing the frontward direction with respect to the imager 12, the seating determination based on the seating likelihood, which may have low accuracy, is not performed, and only the determination of a safe posture based on the movement amount of the object is performed. This reduces the processing burden on the vehicle control apparatus 1. Any detection technology such as YOLO or CNN may be used to determine the orientation of the object. The controller 10 may determine whether the object is facing the frontward direction with respect to the imager 12 based on the feature quantities of the object in the image.

S104: The controller 10 calculates the seating likelihood indicating the likelihood that the posture of the object is a seating posture from the image.

The controller 10 inputs the image captured by the imager 12 into the posture estimation AI stored in advance in the memory 16. The posture estimation AI calculates the seating likelihood based on the input image. The controller 10 may calculate the seating likelihood by another method.

S105: The controller 10 determines whether the seating likelihood is equal to or greater than the likelihood threshold. If the seating likelihood is equal to or greater than the likelihood threshold (S105-Yes), the process proceeds to S106. If the seating likelihood is less than the likelihood threshold (S105-No), the process proceeds to S109.

In S105, the seating determination based on the seating likelihood is performed. In this embodiment, when the seating likelihood is equal to or greater than the likelihood threshold, the determination of a safe posture based on the movement amount of the object is performed, and when the seating likelihood is less than the likelihood threshold, the determination of a safe posture based on the movement amount is not performed. In this embodiment, even when the seating likelihood is equal to or greater than the likelihood threshold, the determination of a safe posture based on the movement amount is performed, thereby increasing the accuracy of the determination of a safe posture.

S106: The controller 10 calculates the movement amount of the object.

The controller 10 may calculate the movement amount of the object by calculating the movement amount per unit time of each feature point (for example, joints) in the object's skeleton and summing the movement amounts per unit time of all feature points. When summing the movement amounts of all feature points, different weighting coefficients may be assigned to each feature point. For example, since the object is safer when the movement amount of the lower body is smaller than that of the upper body, a larger weighting coefficient may be assigned to the joints of the lower body (joints near the waist, knees, feet, etc.) than to the joints of the upper body.

S107: The controller 10 determines whether the movement amount is equal to or less than the movement amount threshold. If the movement amount is equal to or less than the movement amount threshold (S107-YES), the process proceeds to S108. If the movement amount exceeds the movement amount threshold (S107-NO), the process proceeds to S109.

In S107, the determination of a safe posture based on the movement amount of the object is performed. If the movement amount is equal to or less than the movement amount threshold, that is, if the posture of the object is a stationary posture, the object can be considered safe. Therefore, a stationary posture can correspond to a safe posture. If the posture of the object is a safe posture, the object may be seated or not seated.

S108: The controller 10 turns ON the flag indicating that the posture of the object is a safe posture. The process then ends.

S109: The controller 10 turns OFF the flag. Thereafter, the process returns to S101.

The controller 10 repeats S101 to S109 until the flag is ON.

The controller 10 executes the processes from S101 to S109 for each object in the vehicle. If the flag is ON for all objects, the controller 10 permits the vehicle to start. If the flag is OFF for at least one object, the controller 10 does not permit the vehicle to start.

### Operation Flow of Vehicle Control Apparatus 1 According to Another Embodiment

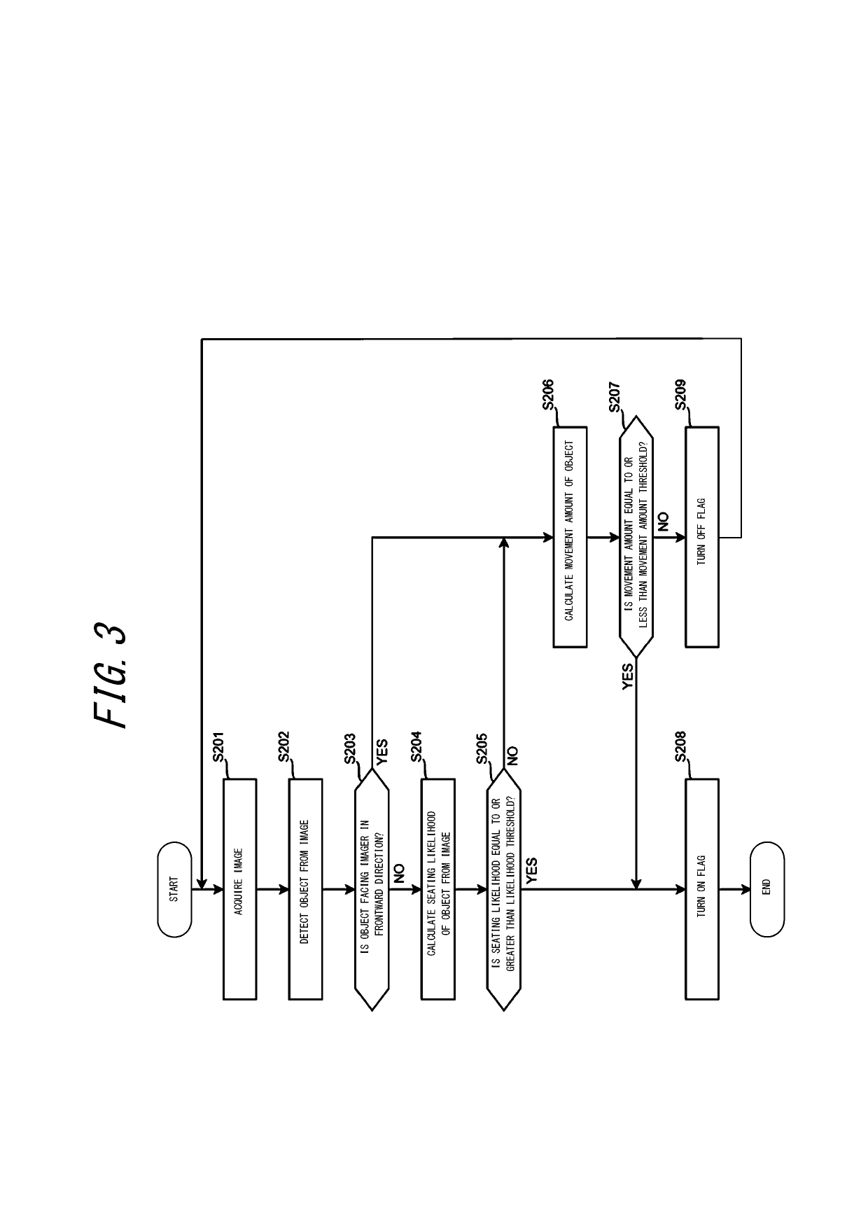

With reference to FIG. 3, the operations of the vehicle control apparatus 1 according to another embodiment will be described. Since the configuration of the vehicle control apparatus 1 according to another embodiment is similar to that shown in FIG. 1, the description is omitted. Among the operations of the vehicle control apparatus 1 according to another embodiment, the processes from S201 to S204 and S206 to S209 are similar to the processes from S101 to S104 and S106 to S109, respectively, so the description is omitted.

S205: The controller 10 determines whether the seating likelihood is equal to or greater than the likelihood threshold. If the seating likelihood is equal to or greater than the likelihood threshold (S205-Yes), the process proceeds to S208. If the seating likelihood is less than the likelihood threshold (S205-No), the process proceeds to S206.

In another embodiment, if the seating likelihood is less than the likelihood threshold, the determination of a safe posture based on the movement amount of the object is performed, and if the seating likelihood is equal to or greater than the likelihood threshold, the determination of a safe posture based on the movement amount is not performed. In another embodiment, if the seating likelihood is above the likelihood threshold, the determination of a safe posture based on the movement amount is not performed, thereby reducing the processing burden on the vehicle control apparatus 1.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided. For example, in the above embodiment, an embodiment in which the configuration and operations of the vehicle control apparatus 1 are distributed to multiple devices or computers capable of communicating with each other can also be implemented.

For example, in the above embodiment, when the controller 10 of the vehicle control apparatus 1 permits the vehicle to start, it may start the vehicle by executing the autonomous driving control of the vehicle. In addition, the vehicle control apparatus 1 may be used to provide Mobility as a Service (MaaS), a service that leverages mobility.

1. A vehicle control apparatus comprising:
a controller; and
an imager configured to capture an image of an interior of a vehicle,
wherein the controller is configured to:
detect an object from the image captured by the imager using an object detection technique;
calculate seating likelihood indicating likelihood that a posture of the object is a seating posture from the image; and
determine whether to perform a determination of a safe posture based on a movement amount of the object based on whether the seating likelihood is equal to or greater than a likelihood threshold, and
performing of the determination of a safe posture based on the movement amount of the object includes:
calculating the movement amount of the object; and
turning on a flag indicating that the posture of the object is a safe posture in a case in which the movement amount is equal to or less than a movement amount threshold, and turning off the flag in a case in which the movement amount exceeds the movement amount threshold.

2. The vehicle control apparatus according to claim 1,
wherein determining of whether to perform the determination of a safe posture based on the movement amount of the object includes
performing the determination of a safe posture based on the movement amount in a case in which the seating likelihood is equal to or greater than the likelihood threshold, and turning off the flag without performing the determination of a safe posture based on the movement amount in a case in which the seating likelihood is less than the likelihood threshold.

3. The vehicle control apparatus according to claim 1,
wherein determining of whether to perform the determination of a safe posture based on the movement amount of the object includes
turning on the flag without performing the determination of a safe posture based on the movement amount in a case in which the seating likelihood is equal to or greater than the likelihood threshold, and performing the determination of a safe posture based on the movement amount in a case in which the seating likelihood is less than the likelihood threshold.

4. The vehicle control apparatus according to claim 1,
wherein the controller is further configured to perform the determination based on the movement amount without calculating the seating likelihood in a case in which the object is facing the imager in a frontward direction, and
the frontward direction is a direction tilted within a range of 0 degrees to less than 45 degrees with respect to a direction from the object to the imager.

5. The vehicle control apparatus according to claim 1, wherein the controller is configured to:
permit the vehicle to start in a case in which the flag is turned on for all objects in the vehicle; and
not permit the vehicle to start in a case in the flag is turned off for at least one object in the vehicle.

6. The vehicle control apparatus according to claim 2, wherein the controller is configured to:
permit the vehicle to start in a case in which the flag is turned on for all objects in the vehicle; and
not permit the vehicle to start in a case in the flag is turned off for at least one object in the vehicle.

7. The vehicle control apparatus according to claim 3, wherein the controller is configured to:
permit the vehicle to start in a case in which the flag is turned on for all objects in the vehicle; and
not permit the vehicle to start in a case in the flag is turned off for at least one object in the vehicle.

8. The vehicle control apparatus according to claim 4, wherein the controller is configured to:
permit the vehicle to start in a case in which the flag is turned on for all objects in the vehicle; and
not permit the vehicle to start in a case in the flag is turned off for at least one object in the vehicle.

9. A method, by a processor, for improving travel mobility as a service (MaaS), comprising processing steps executed by the vehicle control apparatus according to claim 1.
